(19) United States
(12) Patent Application Publication
(10) Pub. No.: US 2012/0006208 A1
(43) Pub. Date: Jan. 12, 2012

(54) PAN

(76) Inventors: Otto Schroeder, Mineola, NY (US); Annette Gucciardo, Mineola, NY (US)

(21) Appl. No.: 13/176,402

(22) Filed: Jul. 5, 2011

Related U.S. Application Data
(60) Provisional application No. 61/362,392, filed on Jul. 8, 2010.

(51) Int. Cl. A47J 37/10

(52) U.S. Cl. 99/422

(57) ABSTRACT

An improved frying pan configured with two surfaces/levels, the first cooking surface used to cook foods and a second surface (a convenient food storage shelf) used to hold/store foods having a slope or pitch towards the outer perimeter of the frying pan. The storage shelf allows the user to store ingredients on the pan itself without the need for additional holding plates. The outward pitch of the food storage shelf along with its ridges allows liquids such as fats and oils to drain away from the ingredients and stop them from re-entering the lower cooking surface. Therefore liquids will not combine with the food in the lower cooking surface and will not combine with other food ingredients when they are cooked.

### CROSS-REFERENCE TO RELATED APPLICATION

This application is a non-provisional utility patent application, and claims the benefit of U.S. Provisional Patent Application Ser. No. 61/362,392, filed on Jul. 8, 2010 which is expressly incorporated herein in its entirety by reference thereto.

### FIELD OF THE INVENTION

Frying pans are popular cooking utensils because they allow the user to prepare a multitude of food dishes and to utilize various cooking techniques on foods. Specifically, frying pans can be used to sauté, braise, sear, fry, brown and even grill foods. The same food may be subjected to multiple cooking techniques in sequence and/or the different food ingredients may be cooked differently. Many food dishes require the user to cook various ingredients in stages using the same or different techniques and to then combine all the ingredients at the end of the cooking process. This segmented cooking process creates the need for additional plates and bowls in which to store the cooked ingredients until all of them are finally combined. As a result, more dishes and plates need to be cleaned after cooking, more pans or cooking bowls are needed to keep the food warm, and space is sometimes limited. Sometimes it is also desirable to keep certain fats and oils used to prepare or cook individual ingredients separate and apart from other foods or the final food product.

The present invention is an improved frying pan configured with two surfaces/levels, the first cooking surface used to cook foods and a second surface (a food storage shelf) having a slope or pitch towards the perimeter of the frying pan used to hold/store foods. The storage shelf allows the user to store ingredients on the pan itself without the need for additional holding plates. The outward pitch of the food storage shelf allows liquids such as fats and oils to drain away from the ingredients on the shelf and stop it from re-entering the lower cooking surface during storage so that the liquids (e.g., fats and oils) do not combine with the food in the lower cooking surface and do not combine with other food ingredients when they are cooked.

### BACKGROUND OF THE INVENTION

Frying pans are versatile cooking utensils. As their name suggests, frying pans are used to fry foods. In addition to their most basic function, frying pans can also be used to sear, brown, sauté and even grill foods, depending on the pan's configuration. As a result of their usefulness, frying pans are very popular and can be found in both the kitchens of commercial establishments and in those of most residential homes. Frying pans are generally round or circular in shape and are commonly constructed of steel, cast iron, aluminum, copper, or other metals. Many frying pans also feature a non-stick coating to help prevent foods from sticking to their cooking surface. Most often, a pan has a flat cooking surface (base) that rests on the stove burners surrounded by a side wall around the entire circumference that helps keep the food in the cooking area. One or more handles are usually incorporated into the pan, typically connected to the side wall providing a means to hold the pan and to move and position it.

Typically, when cooking foods in a frying pan some form of lipid is introduced into the pan such as oil, lard, butter and/or margarine. Foods that are themselves fatty or oily in nature, such as bacon, would require much less or even no lipids when being cooked. In addition to acting as a lubricant between the pan and the foods, the lipids add flavor and may help decrease the overall cooking time of the food.

Although the added lipids offer many benefits, they also come with some drawbacks. The fat and cholesterol content of the food being prepared increases in proportion to the amount of lipids used when preparing the food. Sometimes, it is therefore beneficial and/or desirable to minimize the amount of lipids in the final food product.

Often times when cooking foods and preparing food dishes, the foods are cooked separately and then combined in the end. One reason for this is that the ingredients and components in a single food dish may require different times to fully cook. Another reason is that the ingredients and components may need to be cooked at different temperatures or using different cooking styles. When using one frying pan, it is common to cook ingredients or components separately and to remove them from the pan to prevent overcooking and then reintroduce them at a later stage of the cooking process. Ingredients removed from the frying pan are typically placed on a separate plate, bowl, or similar holding tray until they need to be reintroduced into the pan. This requires the user to use an additional plate(s) while cooking the other ingredients which increases the cleanup efforts.

Cooked ingredients that have been removed from the pan can get cold which may affect their flavor. With the need for the additional plates comes the need for a larger area to prepare the food and a place to rest those plates while the user performs the rest of the cooking.

It would be very beneficial to have a frying pan that could allow for the separation and storage of ingredients within the pan during the cooking process but outside the cooking surface of the pan, an area that the cooked food can easily be transferred in and out of when cooking other foods or food components. Such an area, if appropriately positioned, would keep the food warm without cooking it and would also help collect and drain out undesired liquids.

### SUMMARY OF THE INVENTION

The present invention overcomes the foregoing and other shortcomings and drawbacks associated with currently available frying pans. While the invention will be described in connection with certain embodiments, it will be understood that the invention is not limited to those embodiments. To the contrary, the invention includes all alternatives, modifications and equivalents as may be included within the spirit and scope of the present invention.

The improved frying pan is configured with two surfaces/levels, the first cooking surface used to cook foods and a second surface (a food storage shelf) used to hold/store foods having a slope or pitch towards the outer perimeter of the frying pan. The accessibility of the storage shelf allows the user to store ingredients before and after cooking on the pan itself without the need for additional holding plates. The outward pitch of the food storage shelf allows liquids such as fats and oils to drain away from the ingredients on the shelf and stop it from re-entering the lower cooking surface during storage so that the liquids do not combine with the food in the lower cooking surface and do not combine with other food ingredients when they are cooked.

### DESCRIPTION OF THE DRAWINGS

FIGS. 1-7 show one embodiment of the invention.

FIGS. 8-15 show another embodiment of the invention with example dimensions.

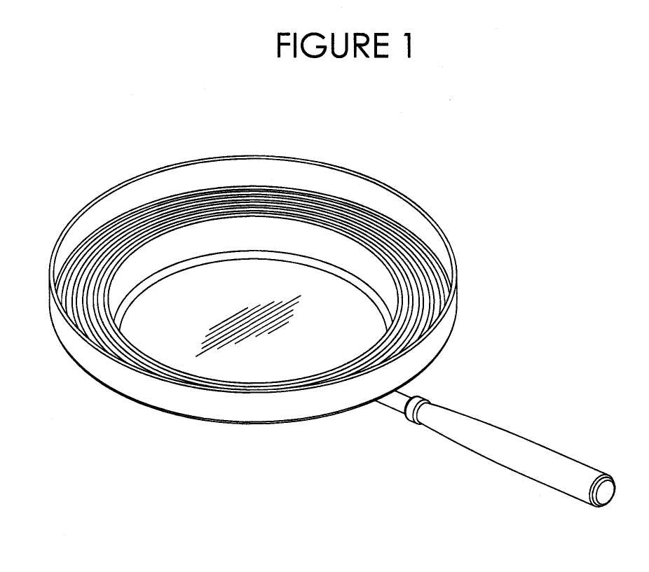

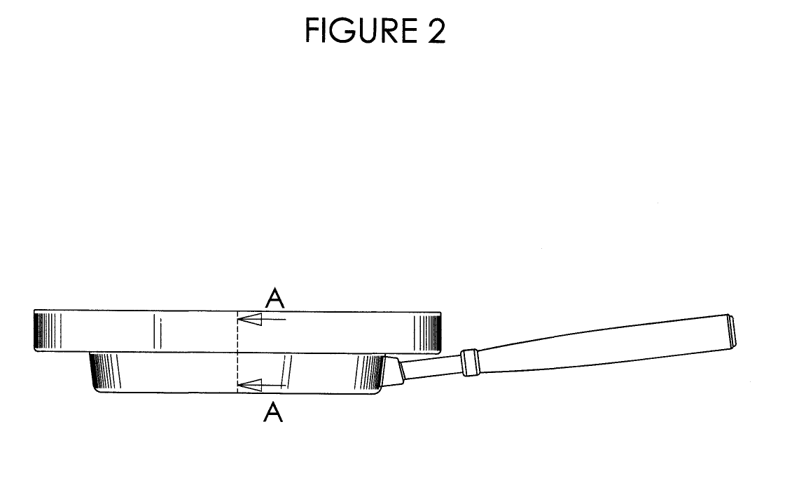

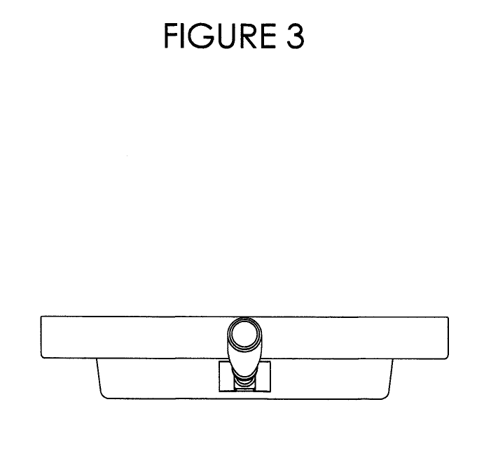

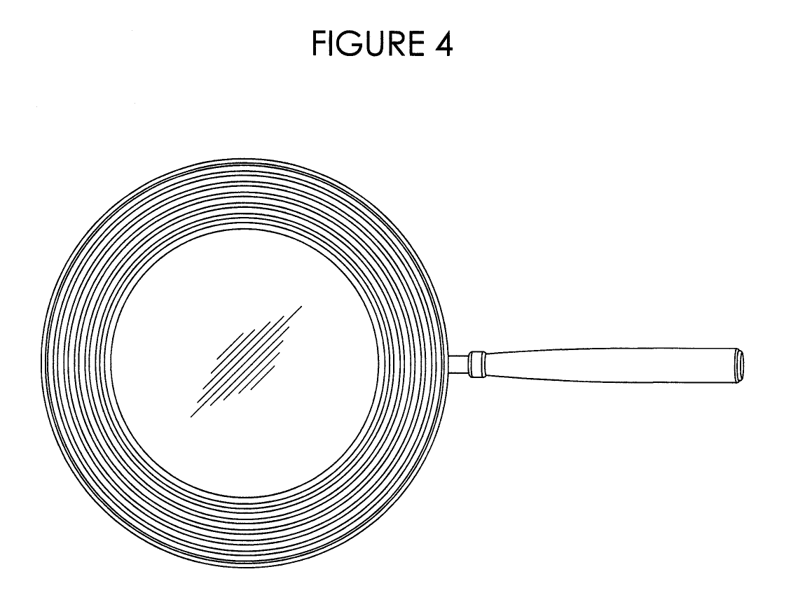

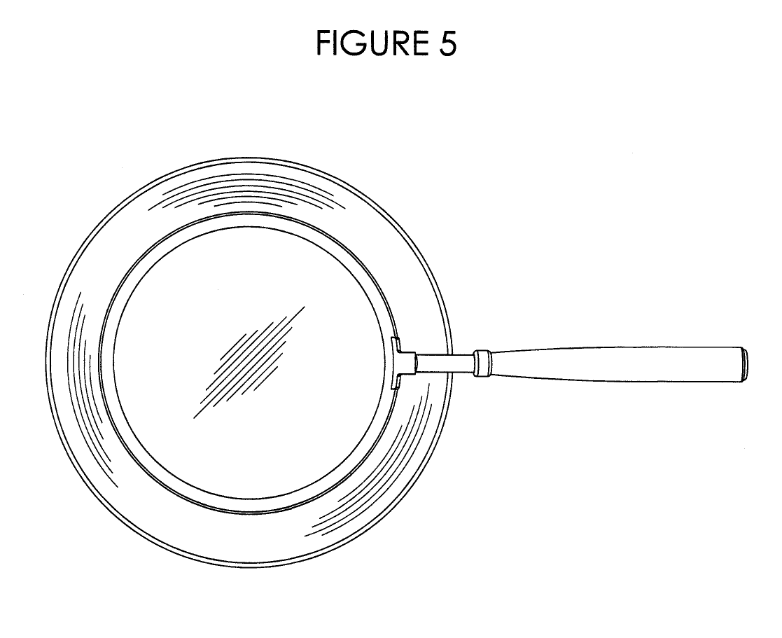

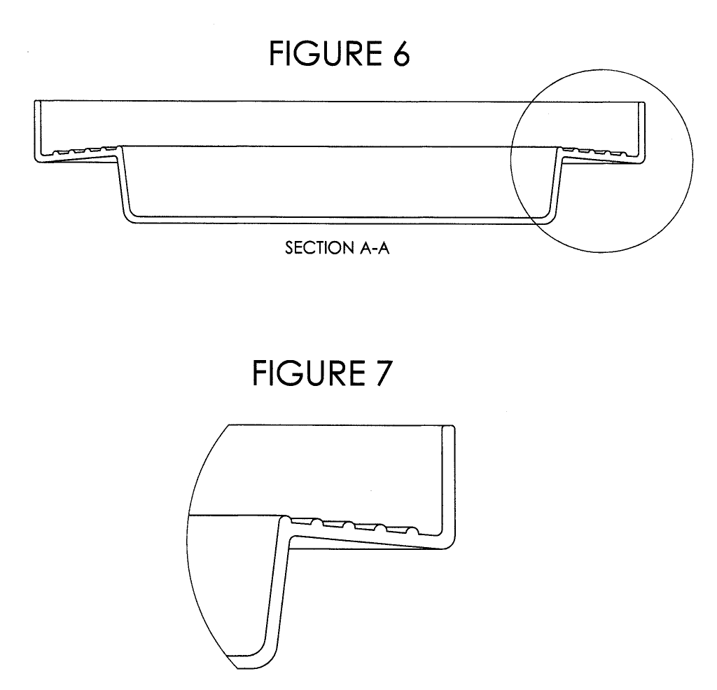

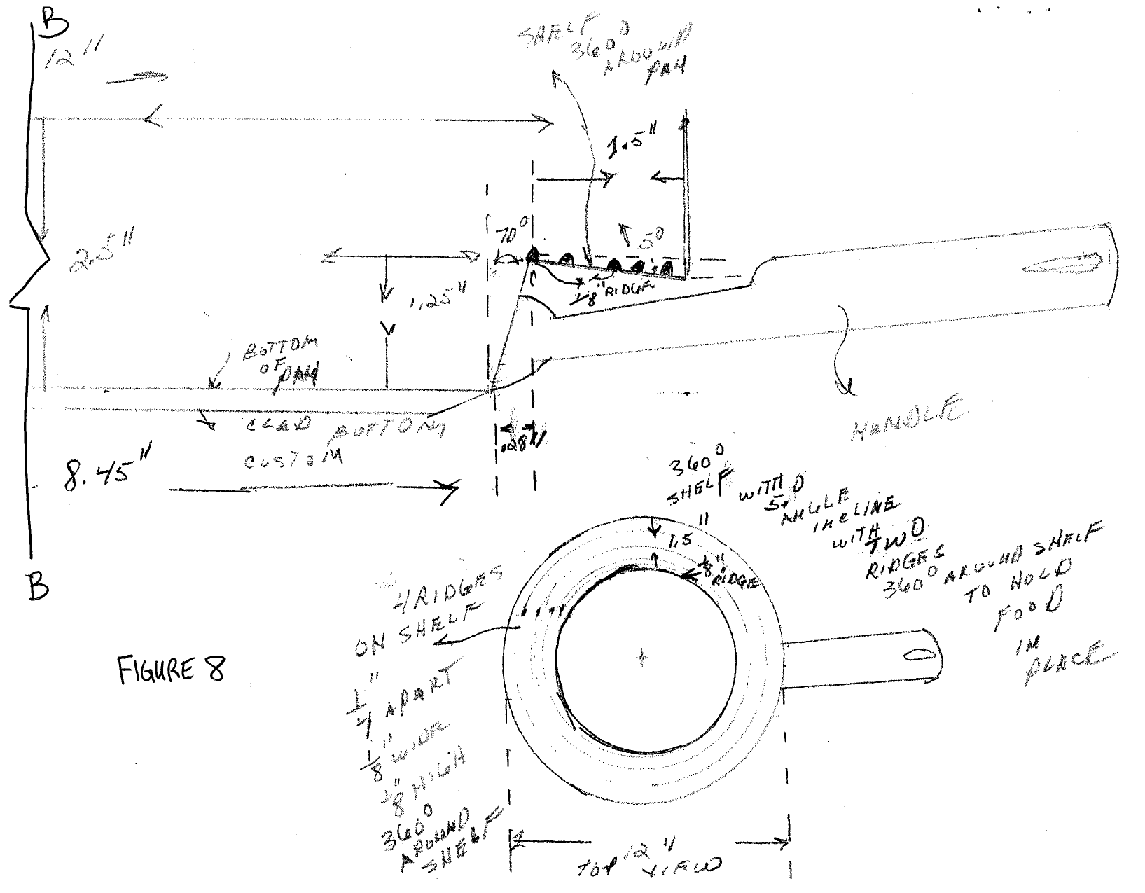

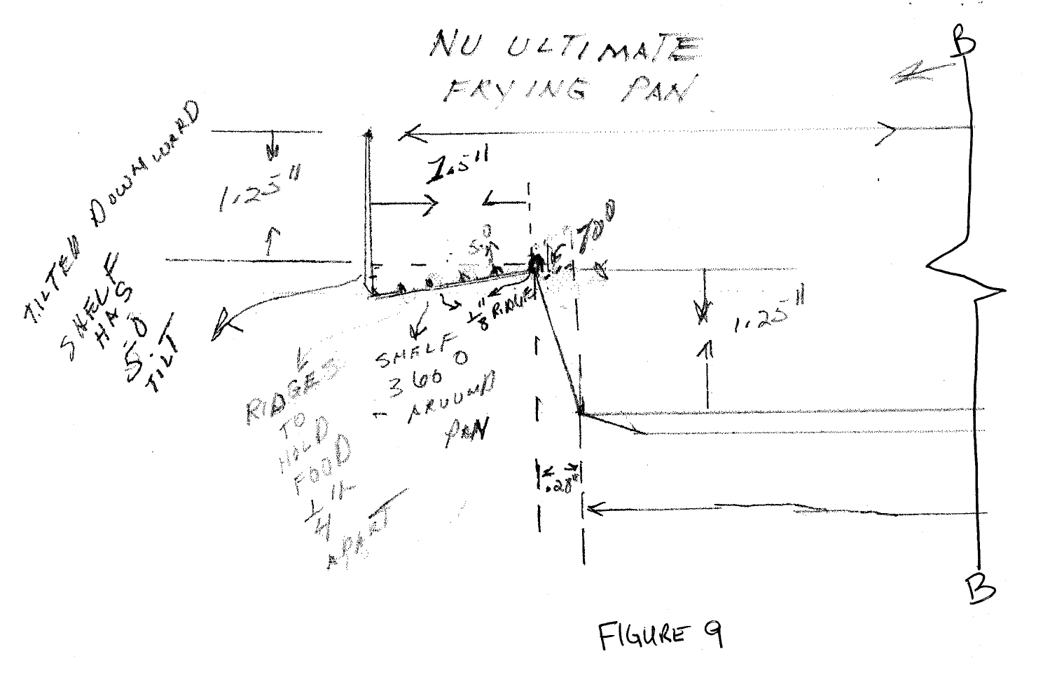

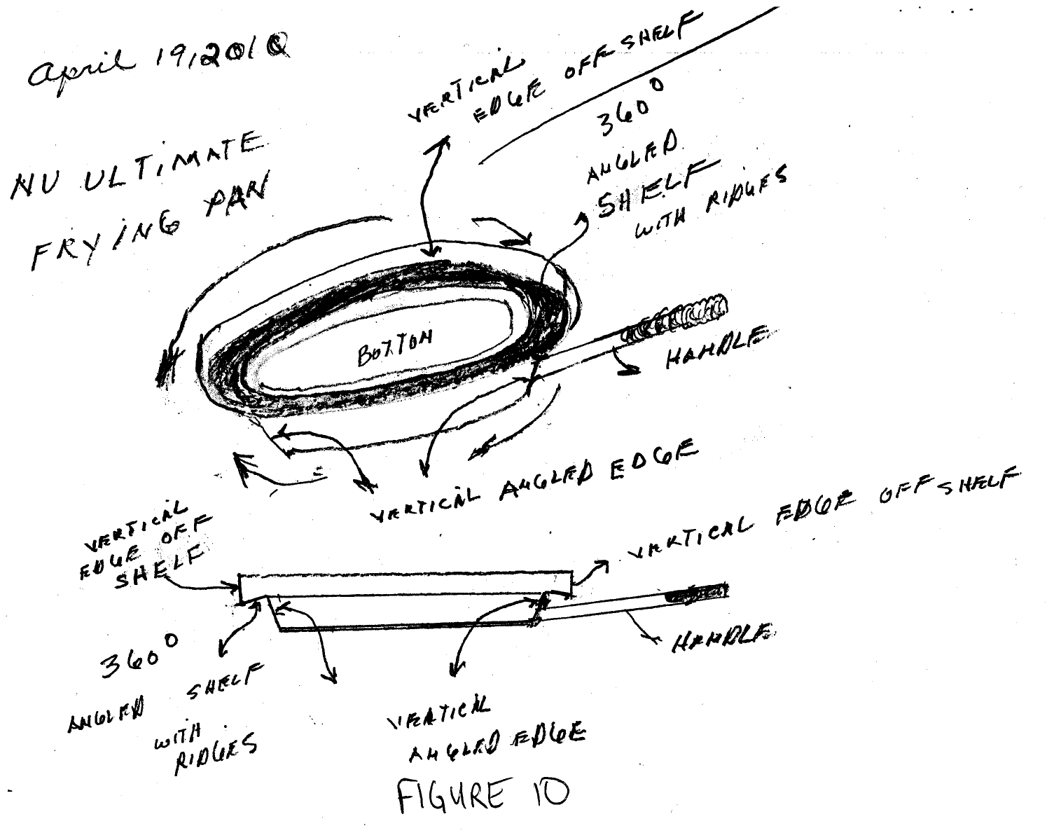

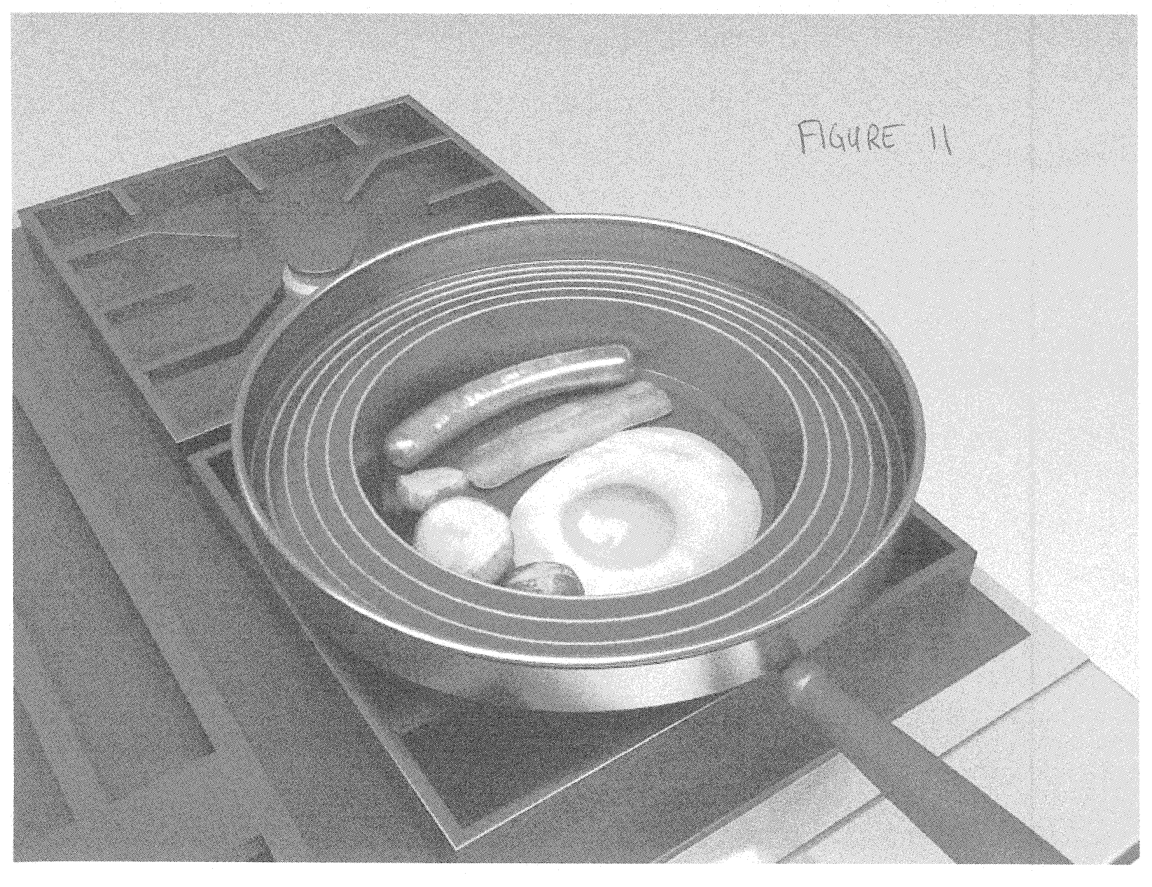

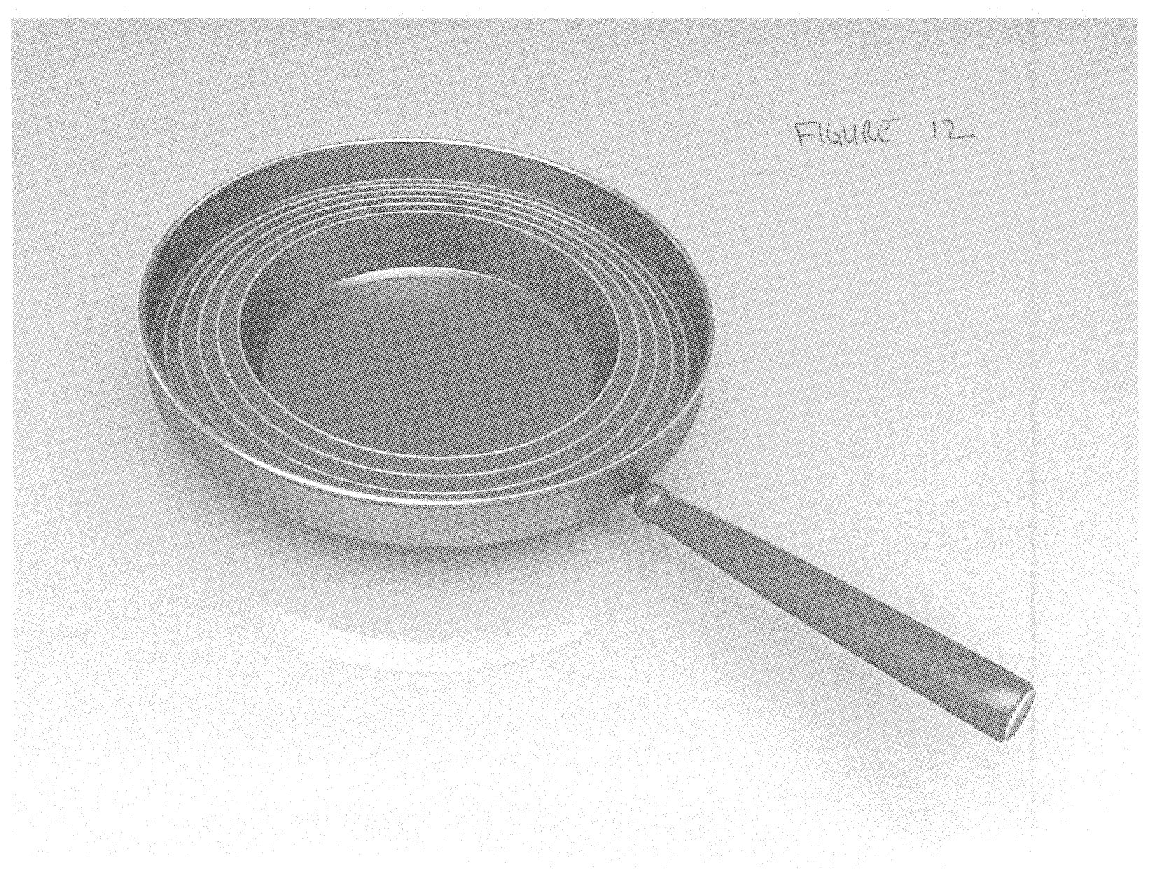

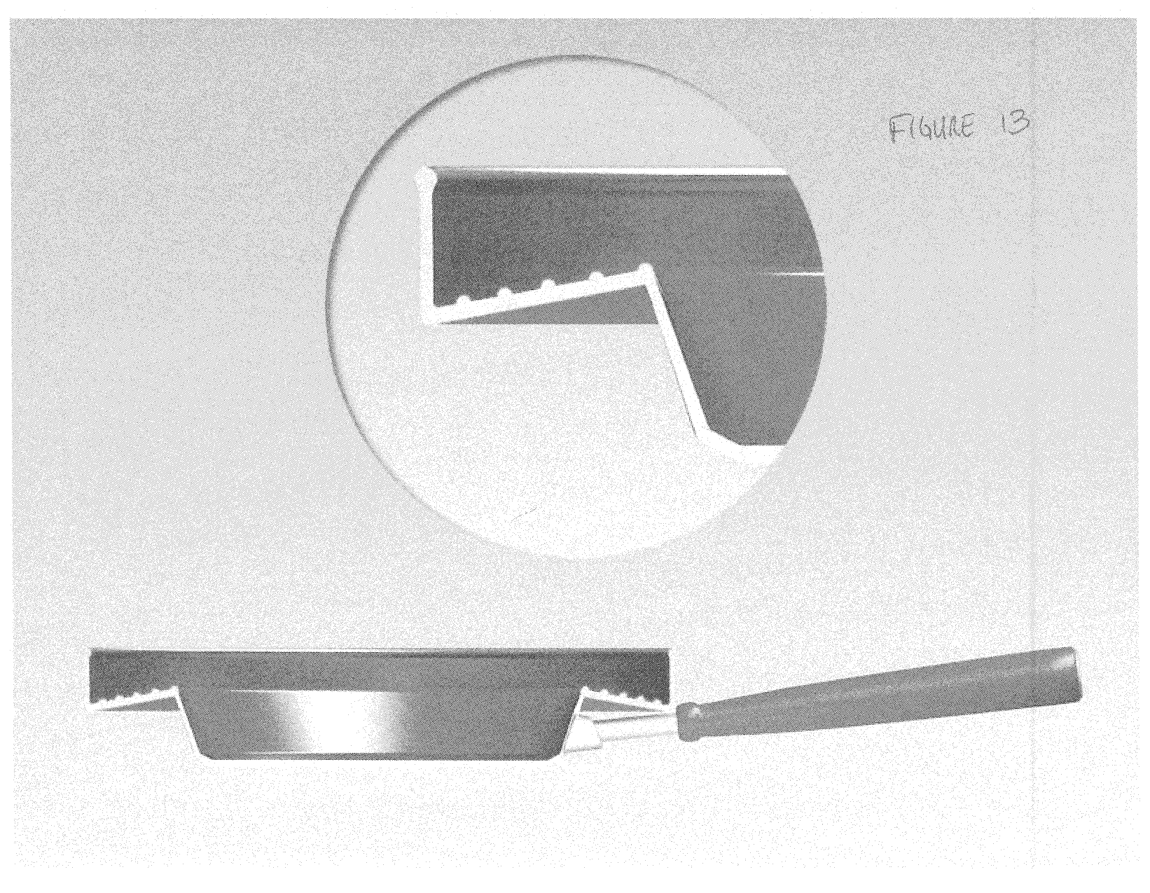

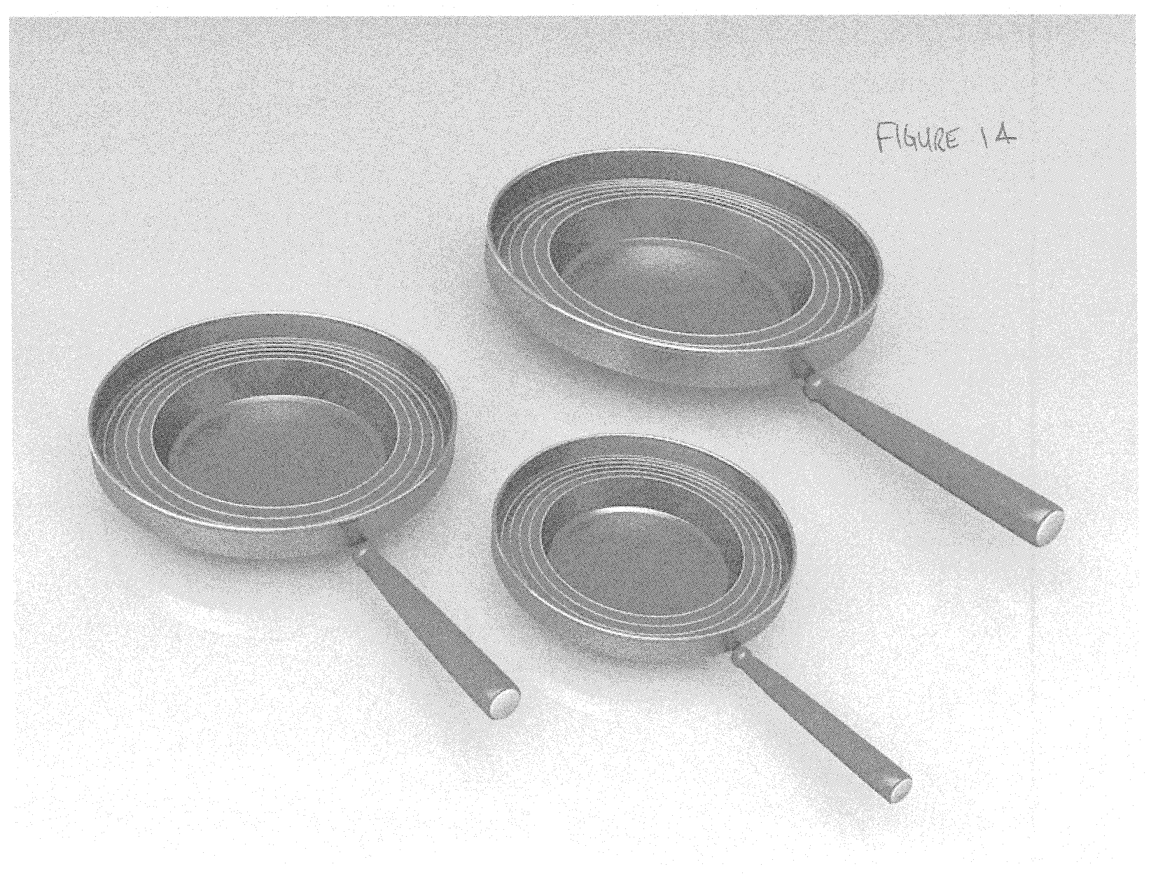

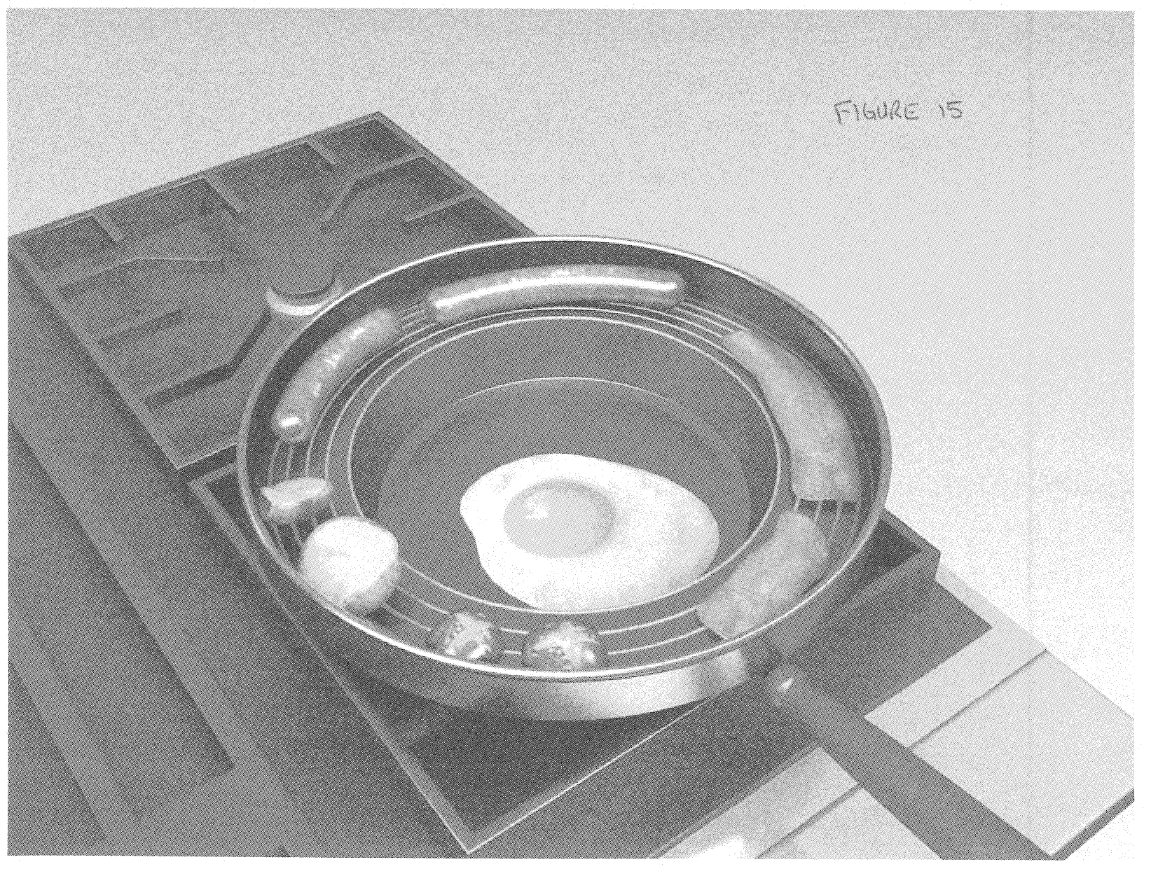

### DETAILED DESCRIPTION OF THE DRAWINGS

The present invention provides a frying pan comprising a frying pan body and a handle. The frying pan body is generally comprised of a base, a base side wall, a food storage shelf, a recessed channel within the food storage shelf, and a food storage shelf side wall. The base is generally circular but may be other shapes such as rectangular, oval and irregular shapes. The upper surface of the base comprises the pan's primary cooking surface. The lower surface is intended to be placed on the cooking surface such as the oven or stove. The dimensions of the base (e.g., the diameter, length and width, etc.) can be varied for different sized pans with varied cooking surfaces. When the pan is used to cook food, the lower surface of the base is positioned on a stove top range so that heat from the range transfers to the lower surface of the pan base thereby heating the frying pan. The perimeter of the body has a side wall which extends about perpendicular from the base perimeter (the outer circumference if the pan base is circular) around the perimeter of the pan base. The transition between the base and the side wall can be abrupt forming an edge or can be gradual forming an arch. The height of the side wall can vary from one embodiment to another. The side wall height may be selected based upon the overall dimensions of the pan and the desired volume inside the base and side walls. The pan side wall features an inner and an outer surface, the inner surface being in contact with the inner surface of the base. In one embodiment, the height of the pan side wall is approximately 1¼ inches tall. Preferably, the height of the pan side wall is uniform along the perimeter of the pan, although in different embodiments of the invention, the height of the wall can be varied at different points along its length. The top of the pan side wall has the food shelf attached to it. The pan side wall encloses the internal cooking surface of the pan, preventing food which is being cooked in the frying pan from easily exiting the pan. Heat that dissipates from the pan base typically travels to the pan side wall causing the side wall to become hot or warm. When heated, the pan side wall can also act to increase the pan's overall cooking surface. Preferably, for a circular pan, the pan side wall is gradually sloped away from perpendicular from the pan base so that the circumference of the circle formed by the top of the pan side wall is slightly larger than the circumference of the pan base. In one embodiment, the diameter of the circle formed by the side wall's top end is approximately 12 inches and the angle at which the side wall slopes away from perpendicular to the pan base is approximately seven degrees (7°). The pan side wall could also be configured so that it is perpendicular to the pan base or can be sloped at a variety of other angles either toward or away from perpendicular to the pan base.

The food shelf is attached to the top of the side wall, preferably in a curved fashion making it easier to slide food and ingredients between the pan's primary cooking surface/base onto the pan food storage shelf as desired. The food storage shelf has an upper surface, where food is stored, and a lower surface. The food storage shelf extends outward from the perimeter of the side wall, preferably with pitch downward and away from the level of the upper end of the side wall. In one embodiment, the food storage shelf slopes away from the top of the pan side wall at an angle of approximately five degrees (5°). The food storage shelf could also be configured so that it is perpendicular to the pan side wall without any downward angle or can also be sloped at a variety of other angles either above or below the top of the side wall. The storage shelf features an upper surface used for food storage. The food shelf's storage surface according to one embodiment of the invention is approximately 1½ inches in width. The upper surface of the food storage shelf may also have one or more ridges to help reduce surface contact with food (to reduce heating and cooking) and to direct liquid is away from the side wall and base. In one embodiment of the invention the upper surface of the food shelf has one ridge around the inner perimeter of the upper surface of the food shelf. In another embodiment, the upper surface of the food shelf has five (5) equally spaced circular ridges around the upper surface of the food storage shelf. Preferably, the ridges, except for the inner most ridge, are slotted at like positions with respect to each other so that liquids may drain away from the side wall and the cooking area toward the outer perimeter of the food storage shelf. The ridges also help keep the food that is being stored on the storage shelf from sliding back onto the base. The ridges also help minimize the contact between the food stored on the shelf and the food storage shelf's upper surface which can also make it easier to move the food on and off the shelf. The heat that travels from the pan base radiates and dissipates upward throughout the pan body and side wall. The ridges help reduce the amount of additional cooking of the food being stored on the food storage shelf while also keeping the food from getting cold.

In one embodiment for a circular pan, each consecutive ring formed by the ridges, starting from the inner perimeter of the food storage shelf is slightly larger in diameter than the one immediately preceding it. In one embodiment, each ridge is approximately ⅛ inches in height, although the specific height of the ridges can be varied from one pan to another and within a single pan. The storage shelf can also be made with more, less, or no ridges than shown in the figures and the ridges can be made with or without slots. The ridges can also be configured in different arrangements. Rather than being circular, the ridges can be configured spiral or perpendicular to the side wall. The ridges can also be configured diagonally, in a zigzag formation, or in various shapes.

The food storage shelf can also include one or more partitions on its upper surface to separate foods and keep liquids that are on the food shelf in different partitions from combining with each other.

In one embodiment, the pan food storage shelf has a recess in its upper surface, preferably at its outer perimeter. The recess or channel may travel around the entire outer perimeter of the food storage shelf and/or it may be segmented as well. In one embodiment, the recess or channel is approximately ⅛ inches in depth but other depths are possible. The recess or channel is configured to capture lipids, juices and moisture that may come off of ingredients or foods being stored on the food storage shelf so that when the stored ingredients are reintroduced into the pan for cooking, those liquids do not reenter the cooking area, preferably, the liquids drain into and remain in the recess or channel. A pitch of the food storage shelf towards the recess or channel assists with the drainage. The food shelf has a shelf side wall along its outer perimeter similar to the side wall for the base. The shelf side wall extends vertically from the outer perimeter of the pan food storage shelf. The height of the shelf side wall can vary depending on the overall dimensions of the pan, the size of the food storage shelf, and/or based on the particular food for which the pan will be used to prepare. The shelf side wall has a top and a bottom. The height of the shelf side wall, according to one embodiment of the invention, from its top to bottom is approximately 1¼ inches tall. The height of the shelf side wall may be uniform along the perimeter of the food storage shelf or it may change in height along the perimeter. The storage side wall encloses the upper surface of the food storage shelf. The food storage side wall helps prevent food which is being stored on the food shelf from falling out of the pan and helps to contain liquids. The top end of the shelf side wall is configured to receive and hold a pan cover which can be optionally used with the invention, depending on the food being prepared and/or according to the user's preference.

The pan can be made of any material suitable for manufacturing frying pans, including but not limited to steel, aluminum, cast iron, copper, etc. The upper and lower surfaces of the base and the food storage area as well as the inner and outer surfaces of the side wall and shelf side wall preferably include a non-stick coating in order to prevent the food and ingredients used from sticking to the frying pan.

The frying pan handle is attached to the pan body. In one embodiment of the invention, the handle is attached to the outer surface of the pan side wall and extends outward, away from the pan. The handle, in other embodiments, can be attached to the pan base, to the lower surface of the food storage shelf, to the shelf side wall or to a combination of two or more of these structures. The pan may also feature more than one handle. The handles can be in different configurations, including straight, curved, or circular/looped, among other possible variations. The handle(s) can be configured to be more ergonomic making them easier to grip and to hold. The handle(s) can be made of any material suitable for insulating the handle from the heat, including ceramic, plastic, or any other heat resistant natural or synthetic material. The handle can also be made using a combination of materials, such as, for example, being constructed using a metal core surrounded by a synthetic heat resistant exterior, such as a heat resistant plastic, thereby making the handle cool to the touch even when the pan is in use and exposed to heat. The handle may be fixed to the pan using a weld connection or a riveted connection.

A frying pan comprising a body comprising a base, a side wall, a food storage shelf, and a shelf side wall; said base comprising an upper surface, a lower surface and a perimeter; said side wall comprising an inner surface, an outer surface, a top, and a bottom, said side wall fixedly attached to said base at said bottom of said side wall at said perimeter of said base, wherein said inner surface of said base and said inner surface of said side wall forming a volume in which to cook foods; a food storage shelf comprising an upper surface, a lower surface, an inner perimeter, and an outer perimeter, said inner perimeter of said food storage shelf fixedly attached to said top of said side wall, wherein said food storage shelf is sloped downward from said inner perimeter to said outer perimeter; and a shelf side wall comprising an inner surface, an outer surface, a top, and a bottom, said bottom of said shelf side wall fixedly attached to said outer perimeter of said food storage shelf.

The pan further comprising a handle fixedly attached to the outer surface of the side wall. Said food storage shelf further comprising a recessed channel within the upper surface of said food storage shelf. Said food storage shelf further comprising a plurality of ridges on said upper surface of said food storage shelf. Said food storage shelf further comprising a plurality of ridges on said upper surface of said food storage shelf.

We claim:

1. A frying pan comprising a body comprising a base, a side wall, a food storage shelf, and a shelf side wall;
said base comprising an upper surface, a lower surface and a perimeter;
said side wall comprising an inner surface, an outer surface, a top, and a bottom, said side wall fixedly attached to said base at said bottom of said side wall at said perimeter of said base, wherein said inner surface of said base and said inner surface of said side wall forming a volume in which to cook foods;
a food storage shelf comprising an upper surface, a lower surface, an inner perimeter, and an outer perimeter, said inner perimeter of said food storage shelf fixedly attached to said top of said side wall, wherein said food storage shelf is sloped downward from said inner perimeter to said outer perimeter; and
a shelf side wall comprising an inner surface, an outer surface, a top, and a bottom, said bottom of said shelf side wall fixedly attached to said outer perimeter of said food storage shelf.

2. The pan of claim 1, further comprising a handle fixedly attached to the outer surface of the side wall.

3. The pan of claim 1, said food storage shelf further comprising a recessed channel within the upper surface of said food storage shelf.

4. The pan of claim 3, said food storage shelf further comprising a plurality of ridges on said upper surface of said food storage shelf.

5. The pan of claim 1, said food storage shelf further comprising a plurality of ridges on said upper surface of said food storage shelf.

6. The pan of claim 1, further comprising a cover wherein said top of said shelf side wall is configured to receive and hold said pan cover.
